(19) United States
(12) Patent Application Publication
(10) Pub. No.: US 2015/0163131 A1
(43) Pub. Date: Jun. 11, 2015

(54) ONLINE APPLICATION TESTING OF GROWN APPLICATION CAPACITY

(71) Applicants: Eric J. Bauer, Freehold, NJ (US); Randee Susan Adams, Naperville, IL (US); Mark J. Price, Southborough, MA (US)

(72) Inventors: Eric J. Bauer, Freehold, NJ (US); Randee Susan Adams, Naperville, IL (US); Mark J. Price, Southborough, MA (US)

(73) Assignee: ALCATEL-LUCENT USA INC., Murray Hill, NJ (US)

(21) Appl. No.: 14/100,416

(22) Filed: Dec. 9, 2013

(51) Int. Cl. H04L 12/721

(52) U.S. Cl. CPC H04L 45/44

(57) ABSTRACT

A capability for online application testing of grown application capacity is presented. The capability for online application testing of grown application capacity enables grown application capacity of a cloud-based application to be tested and validated while the application remains online for handling of live application traffic. The capability for online application testing of grown application capacity enables grown application capacity of a cloud-based application to be tested and validated with minimal impact or risk to the application traffic of the application or the existing application capacity of the application. The capability for online application testing of grown application capacity may support online testing of grown application capacity for various mechanisms for growing application capacity of a cloud-based application (e.g., horizontal growth mechanisms, vertical growth mechanisms, pseudo-vertical growth mechanisms, or the like).

### TECHNICAL FIELD

The disclosure relates generally to cloud-based applications and, more specifically but not exclusively, to testing of cloud-based applications.

### BACKGROUND

The use of cloud-based solutions to host applications, which typically are referred to as cloud-based applications, continues to grow. An important characteristic of a cloud-based application is the ability to increase and decrease the online application capacity of the cloud-based application in order to enable the resource consumption of the cloud-based application to better track variations in the application workload of the cloud-based application. This provides various advantages for the application provider, such as enabling the application provider to assure that sufficient application capacity is online to maintain adequate quality-of-experience for users of the cloud-based application, enabling close management of the operating expense of the application provider, and the like. The application capacity of a cloud-based application generally may be grown elastically, dynamically, or in any other suitable manner. More specifically, application capacity of a cloud-based application may be grown in one or more of the following ways: (1) using application “outgrowth” in which a new application instance is instantiated, (2) using “vertical growth” in which the resources allocated to the existing application instance are increased (e.g., increasing the number of cores allocated to a previously instantiated virtual machine instance or switching-over service from a component hosted in a virtual machine (VM) instance of one size to a component in a VM instance of a different size), or (3) using “horizontal growth” in which additional application components are added to the existing application instance (e.g., increasing the number ‘N’ of application components in an N+K load-shared pool of application components by instantiating one or more additional application components using virtual resources allocated for use by the application instance). In cloud-based application implementations, as well as various other application implementations, it is preferable to test and verify grown application capacity of a cloud-based application prior to official activation of the grown application capacity in order to ensure proper operation of the cloud-based application and, thus, to minimize the risk of service impact caused by applying live application traffic to faulty or inoperable application components.

### SUMMARY OF EMBODIMENTS

Various deficiencies in the prior art are addressed by embodiments for online application testing of grown application capacity.

In at least some embodiments, an apparatus includes a processor and a memory communicatively connected to the processor, where the processor is configured to receive traffic intended for a cloud-based application including a set of in-service application components and an under-test application component, distribute a first portion of the received traffic across the set of in-service application components, and direct a second portion of the received traffic to the under-test application component.

In at least some embodiments, a method includes using a processor and a memory for receiving traffic intended for a cloud-based application including a set of in-service application components and an under-test application component, distributing a first portion of the received traffic across the set of in-service application components, and directing a second portion of the received traffic to the under-test application component.

In at least some embodiments, a computer-readable storage medium stores instructions which, when executed by a computer, cause the computer to perform a method that includes receiving traffic intended for a cloud-based application including a set of in-service application components and an under-test application component, distributing a first portion of the received traffic across the set of in-service application components, and directing a second portion of the received traffic to the under-test application component.

### BRIEF DESCRIPTION OF THE DRAWINGS

The teachings herein can be readily understood by considering the following detailed description in conjunction with the accompanying drawings, in which:

FIG. 1 depicts an exemplary embodiment of a system for online application testing of grown application capacity;

FIG. 2 depicts an exemplary embodiment of a method for online application testing of grown application capacity for a cloud-based application having a set of in-service application components;

FIG. 3 depicts an exemplary embodiment of a method for online application testing of grown application capacity for a cloud-based application having a set of in-service application components; and

FIG. 4 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

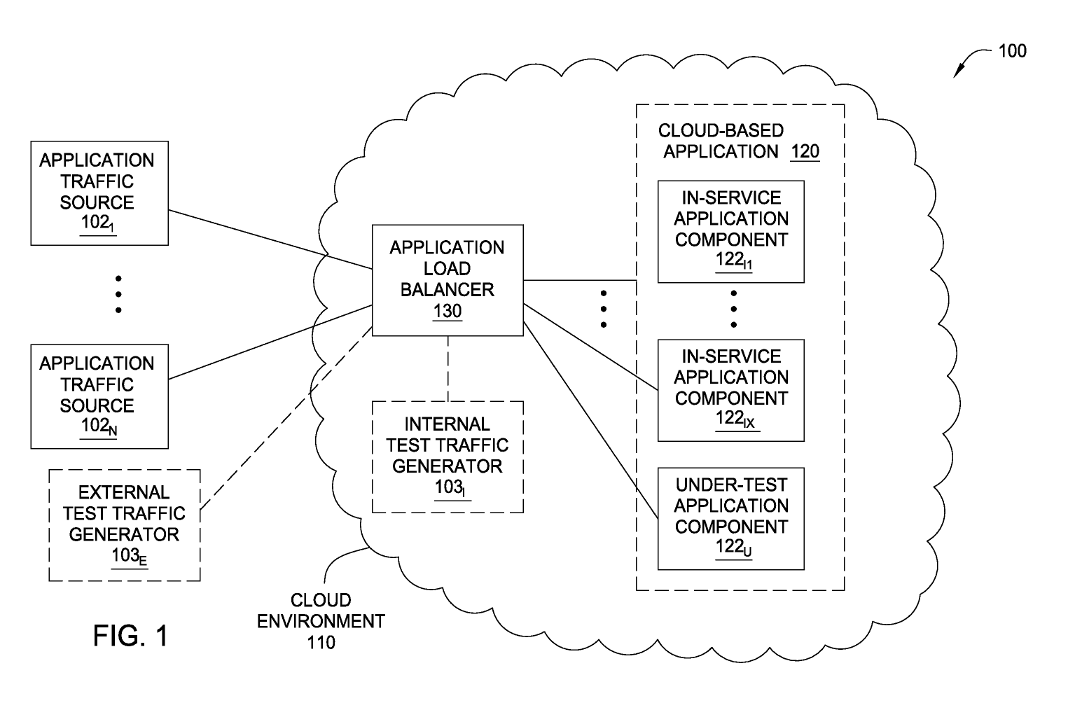

In general, a capability for online application testing of grown application capacity is presented. Various embodiments of the capability for online application testing of grown application capacity enable grown application capacity of a cloud-based application to be tested and validated while the application remains online for handling of application traffic. Various embodiments of the capability for online application testing of grown application capacity enable grown application capacity of a cloud-based application to be tested and validated with minimal impact or risk to the application traffic of the application or the existing application capacity of the application. Various embodiments of the capability for online application testing of grown application capacity may support online testing of grown application capacity for various mechanisms for growing application capacity (e.g., horizontal growth mechanisms, vertical growth mechanisms, pseudo-vertical growth mechanisms, or the like, as well as various combinations thereof). Various embodiments of the capability for online application testing of grown application capacity may be better understood by considering an exemplary system for online application testing of grown application capacity, as depicted in FIG. 1.

FIG. 1 depicts an exemplary embodiment of a system for online application testing of grown application capacity. As depicted in FIG. 1, system 100 includes a set of application traffic sources 102₁-102_{N} (collectively, application traffic sources 102) and a cloud environment 110. The cloud environment 110 includes a cloud-based application 120 and an application load balancer 130. The system 100 also may include a test generator (illustratively, internal test traffic generator 103_{I} deployed within cloud environment 110 or external test traffic generator 103_{E} deployed outside of cloud environment 110) depending on whether application traffic or test traffic is used for online testing of grown application capacity of cloud-based application 120.

The application traffic sources 102 may include any elements configured to produce application traffic intended for cloud-based application 120 of cloud environment 110. For example, the application traffic sources 102 may include user devices (e.g., one or more of a thin client, a smartphone, a tablet computer, a laptop computer, a desktop computer, or the like), network devices (e.g., routers, switches, servers, functions, or the like), virtualized network functions, or the like, as well as various combinations thereof). The application traffic sources 102 may communicate with cloud environment 110 via any communication network(s) suitable for transporting application traffic (e.g., wireline networks, wireless networks, cable-based access networks, Wireless Fidelity (WiFi)-based access networks, cellular access networks, core networks, or the like, as well as various combinations thereof). The application traffic sources 102 access cloud-based application 120 via application load balancer 130. It will be appreciated that, although depicted and described with respect to application traffic sources 102 that are located outside of the cloud environment 110, one or more application traffic sources that produce application traffic for cloud-based application 120 of cloud environment 110 may be located within cloud environment 110.

The cloud environment 110 is an environment configured to support cloud-based implementations of applications (illustratively, the cloud-based application 120). For example, cloud environment 110 may represent a single datacenter, a set of distributed datacenters, a communication network, or the like, as well as various combinations thereof. It will be appreciated that, although omitted for purposes of clarity, cloud environment 110 may include various physical resources configured to host virtual resources (which also may be referred to herein as cloud resources) which are used to provide cloud-based application 120. For example, the physical resources may include physical computing resources (e.g., processors), physical memory resources, physical storage resources, physical networking resources, or the like, as well as various combinations thereof. For example, the virtual resources may include virtual computing resources, virtual memory resources, virtual storage resources, virtual networking resources, or the like, as well as various combinations thereof. It will be appreciated that various combinations of physical resources of the cloud environment 110 may be used to provide virtual resources within the cloud environment 110. It will be appreciated that various combinations of virtual resources of the cloud environment 110 may be used to host cloud-based application (e.g., use of virtual machines (VMs) instantiated on physical resources of the cloud environment 110). The cloud-based application 120 may include any type of application which may be implemented within a cloud environment such as the cloud environment 110. For example, cloud-based application 120 may be a cloud-based file system for a user or group of users. For example, cloud-based application 120 may be a voicemail application, such as where one set of application components is configured to play announcements, one set of application components is configured to record messages left for subscribers, one set of application components is configured to play messages left for subscribers, and so forth. For example, cloud-based application may be a Long Term Evolution (LTE) solution, such as where one set of application components is configured to provide functions of the Serving Gateways (SGWs), one set of application components is configured to provide functions of the Packet Data Network (PDN) Gateways (PGWs), one set of application components is configured to provide functions of the Mobility Management Entity (MME), and so forth. It will be appreciated that the cloud-based application 120 may be any other suitable type of application that may be implemented within cloud environment 110.

The cloud-based application 120 includes a set of in-service application components 122_{I1}-122_{IX} (collectively, in-service application components 122_{I}). The in-service application components 122_{I} each are configured to provide functions of the cloud-based application 120. The in-service application components 122, are in an IN-SERVICE state, which is indicative that the application components have been tested and verified for handing of live application traffic. The in-service application components 122_{I} each are configured to handle application traffic directed to cloud-based application 120. For example, each of the in-service application components 122_{I} may be configured to receive an application request, process the application request in accordance with functions of the cloud-based application 120, and, when necessary, provide an associated application response to the application request. The application requests received and processed by in-service application components 122_{I} may be received from application traffic sources 102 or any other suitable source(s) of application requests for cloud-based application 120. The in-service application components 122_{I} are provided using virtual resources of cloud environment 110. For example, each of the in-service application components 122_{I} may be implemented as a virtual machine (VM) within cloud environment 110. It is noted that the set of in-service application components 122_{I} may include one or more in-service application components 122_{I}.

The application load balancer 130 is configured to provide load balancing of application traffic for cloud-based application 120. The application load balancer 130 performs load balancing by distributing application traffic for cloud-based application 120 across the in-service application components 122_{I}. The application load balancer 130 may distribute application traffic for cloud-based application 120 across the in-service application components 122_{I} using any suitable load balancing techniques (e.g., round-robin, hashing, or the like, as well as various combinations thereof). The application load balancer 130 may be configured to receive application requests and distribute the application requests across the in-service application components 122_{I}. The application load balancer 130 also may be configured to receive application responses from the in-service application components 122_{I} and propagate the associated application responses toward the sources of the corresponding application requests, respectively. For example, upon receiving from one of the application traffic sources 102 an application request that is intended for cloud-based application 120, application load balancer 130 selects one of the in-service application components 122_{I} to handle the application request, provides the application request to the selected one of the in-service application components 122_{I}, receives the corresponding application response from the selected one of the in-service application components 122_{I}, and provides the application response to the one of the application traffic sources 102 which initiated the application request. The handling of application traffic by in-service application components of a cloud-based application will be understood by one skilled in the art.

The cloud-based application 120, in addition to in-service application components 122_{I}, also includes an under-test application component 122. The under-test application component 122_{U} is an application component providing growth of application capacity for cloud-based application 120 (and, thus, also may be referred to as a grown application component of the cloud-based application 120 or grown application capacity of the cloud-based application 120). The under-test application component 122, like each of the in-service application components 122_{I}, is provided using virtual resources of cloud environment 110. For example, the under-test application component 122_{U} may be implemented as a VM within cloud environment 110. The under-test application component 122_{U} is in an UNDER-TEST state, which is indicative that the application component has not yet been tested and verified for “full service” handling of application traffic (i.e., changed from the UNDER-TEST state to the IN-SERVICE state, such that it is moved into the set of in-service application components 122_{I}).

The application capacity of cloud-based application 120 may be grown in response to any suitable trigger condition. For example, application capacity of cloud-based application 120 may be grown responsive to receipt of a user-initiated or automatically-initiated request for additional application capacity for cloud-based application 120, based on a predetermined schedule of application capacity changes for cloud-based application 120 (e.g., dynamic addition and removal of application capacity at different times based on expected load on the cloud-based application 120 at different times), detection that in-service application components 122_{I} are insufficient to handle the current load of application traffic for cloud-based application 120, or the like, as well as various combinations thereof.

The application capacity of cloud-based application 120 may be grown in any suitable manner and, similarly, the manner in which under-test application component 122_{U} becomes associated with cloud-based application 120 as an UNDER-TEST application component may depend on the manner in which the application capacity of the cloud-based application is being grown. In the case of horizontally grown application capacity, for example, under-test application component 122_{U} may be new application component (e.g., where a new application component is instantiated and placed into the UNDER-TEST state for testing and verification before being placed into the IN-SERVICE state). In the case of vertically grown application capacity, for example, under-test application component 122_{U} may be an existing application component that was changed from the IN-SERVICE state to the UNDER-TEST state (e.g., the resources allocated to the existing application component are increased and the existing application component having the increased application capacity is placed into the UNDER-TEST state for testing and verification before being switched back to the IN-SERVICE state). In the case of pseudo-vertically grown application capacity in which an existing application component is swapped for a new application component, for example, under-test application component 122_{U} may be a new application component that is intended to replace one or more of the in-service application components 122_{I} (e.g., a new application component is instantiated and placed into the UNDER-TEST state for testing and verification before being placed into the IN-SERVICE state such that application traffic may be migrated onto the new application component from one or more of the in-service application components 122_{I} being replaced by the new application component). Accordingly, it will be appreciated that the UNDER-TEST state of a grown application component is an important phase in the lifecycle of the grown application component.

The under-test application component 122_{U} is expected to be configured to provide functions of cloud-based application 120; however, since the under-test application component 122_{U} has not yet been tested and validated, the proper functioning of the under-test application component 122_{U} to provide functions of the cloud-based application 120 has not yet been confirmed. The under-test application component 122_{U} needs to be tested such that the proper operation of the under-test application component 122_{U} may be verified before the under-test application component 122_{U} is put into full service for handling of application traffic (i.e., changed from the UNDER-TEST state to the IN-SERVICE state, such that it is moved into the set of in-service application components 122_{I}). This is due to the fact that application capacity growth will occasionally fail for various potential reasons (e.g., faulty configuration of the VM instance providing the grown application component, faulty configuration of the networking supporting the VM instance providing the grown application component, or the like). In many cases, some of these failures impacting grown application capacity will not be critical and, thus, may not be identified until application traffic is applied to the grown application capacity. For example, failure of the application software to boot on a grown application component will become apparent almost immediately and, thus, can be addressed before the grown application component begins receiving application traffic. By contrast, some subtle and configuration-related problems may not become apparent until application service code is executed. For example, a grown application component may boot successfully, but configuration data or security credentials required to access a database may be wrong, such that the grown application component may not be able to access data necessary to properly serve application traffic. Accordingly, given that at least some failures of newly grown application capacity are not immediately detectable, there is a risk that a faulty application component may be introduced to service as part of the cloud-based application and, thus, that some impairments that negatively impact the service provided by the cloud-based application (e.g., a partial capacity loss outage or the like) may become apparent only after live application traffic is provided to the faulty application component. It is noted that, while a cloud-based application may support various mechanisms to detect and mitigate various impairments that negatively impact the service provided by the cloud-based application, such mechanisms are only applied after the service provided by the cloud-based application has been negatively impacted. While this may be acceptable for certain consumer applications, it is unlikely to be unacceptable for certain critical applications.

Accordingly, as indicated above, proper operation of under-test application component 122_{U} needs to be tested and verified before the under-test application component 122_{U} is put into full service for handling of live application traffic (i.e., changed from the UNDER-TEST state to the IN-SERVICE state, such that it is moved to the set of in-service application components 122_{I}).

The application load balancer 130 is configured to support online testing of under-test application component 122_{U} in order to enable the proper operation of under-test application component 122_{U} to be verified before the under-test application component 122_{U} is put into full service (i.e., changed from the UNDER-TEST state to the IN-SERVICE state, such that it is moved to the set of in-service application components 122_{I}). The application load balancer 130 is configured to understand that the application components 122 of cloud-based application 120 have respective states associated therewith (namely, IN-SERVICE or UNDER-TEST, and possibly others which have been omitted for purposes of clarity) and, further to direct application traffic to the application components 122 of cloud-based application 120 in a manner enabling online testing of the under-test application components 122_{U} designated as being UNDER-TEST with minimal impact or risk to handling of application traffic by the in-service application components 122_{I} designated as being IN-SERVICE.

The online testing of under-test application component 122_{U} may be performed using dedicated test traffic or using portions of application traffic, which may depend on various factors (e.g., availability of a test traffic generator to generate test traffic, whether or not characteristics of the application traffic for the cloud-based application 120 support explicit identification of test traffic, whether or not application load balancer 130 is configured to distinguish between test traffic and application traffic, the type of capacity growth mechanism used to grow the application capacity of cloud-based application 120, or the like, as well as various combinations thereof).

In at least some embodiments, in which online testing of under-test application component 122_{U} is performed using dedicated test traffic, the application load balancer 130 may be configured to receive the application traffic and test traffic, distinguish between the application traffic and the test traffic, and direct the application traffic to in-service application components 122_{I} (e.g., distributing the application traffic across the in-service application components 122_{I} using load balancing) and direct the test traffic to under-test application component 122_{U}. The application traffic may be received from one or more devices using cloud-based application 120 (e.g., one or more of the application traffic sources 102). The test traffic may be received from one or more devices generating test traffic for testing of cloud-based application (e.g., internal test traffic generator 103_{I} deployed within cloud environment 110 or external test traffic generator 103_{E} deployed). The application load balancer 130 may be configured to distinguish between the application traffic and test traffic based on information included within the packets received by application load balancer 130. For example, application load balancer 130 may be configured to distinguish between the application traffic and test traffic based on source address information included in the headers of the packets received by application load balancer 130 (e.g., identifying packets having a source address of a test traffic generator 103 as being test packets and identifying packets having other source addresses as being application packets). For example, application load balancer 130 may be configured to distinguish between the application traffic and test traffic based on test traffic indicator information included in the test packets (e.g., identifying packets having TestTraffic=TRUE as being test packets and identifying packets omitting the TestTraffic parameter (or having TestTraffic=FALSE) as being application packets). It will be appreciated that the application load balancer 130 may be configured to distinguish between application traffic and test traffic in other ways. In other words, in embodiments in which online testing of under-test application component 122_{U} is performed using dedicated test traffic, the application load balancer 130 may be configured to segregate application traffic and test traffic (e.g., segregate application traffic received from application traffic sources 102 and test traffic received from the test traffic generator(s) 103).

In at least some embodiments, in which online testing of under-test application component 122_{U} is performed using application traffic, the application load balancer 130 may be configured to receive the application traffic, and direct a first portion of the application traffic to the in-service application components 122, (e.g., distributing the first portion of the application traffic across the in-service application components 122_{I} using load balancing) and direct a second portion of the application traffic to under-test application component 122_{U}.

In at least some embodiments, application load balancer 130 may select the second portion of received application traffic that is to be used as test traffic for under-test application component 122_{U} as a percentage of the application traffic received by application load balancer 130 (e.g., X % of received application traffic is directed to under-test application component 122_{U} and the remaining 100-X % of received application traffic is distributed across the in-service application components 122_{I}), a defined amount of application traffic received by application load balancer 130 (e.g., 10 MB of received application traffic is directed to under-test application component 122_{U} and the remaining portion of the received application traffic is distributed across the in-service application components 122_{I}), based on defined time intervals during which application traffic received by application load balancer 130 is directed to under-test application component 122_{U} rather than being distributed across the in-service application components 122_{I}, or the like, as well as various combinations thereof.

In at least some embodiments, the size of the second portion of application traffic that is directed to the under-test application component 122_{U} may depend on the amount of application traffic being handled or expected to be handled by each of the in-service application components 122_{I}. In at least some embodiments, the size of the second portion of application traffic that is directed to the under-test application component 122_{U} may be less than or significantly less than the amount of application traffic being handled or expected to be handled by each of the in-service application components 122_{I}. For example, where the set of in-service application components 122_{I} includes ten in-service application components 122_{I} and each of the ten in-service application components 122_{I} is configured to handle 10% of the application traffic for the cloud-based application 120, the application load balancer 130 may initially direct less than 10% of the received application traffic to under-test application component 122_{U} (e.g., 5%, 2%, 1%, or any other suitable amount). It is noted that the size of the second portion of application traffic that is directed to the under-test application component 122_{U} may depend on various factors, such as complexity of the functions provided by the cloud-based application 120, the importance of the application traffic handled by the cloud-based application 120, or the like.

In at least some embodiments, the size of the second portion of application traffic that is directed to the under-test application component 122_{U} is static and the proper operation of the under-test application component 122_{U} is validated based on handling of that static size of the second portion of application traffic by under-test application component 122_{U}. For example, in continuation of the example discussed above, the application load balancer 130 may initially direct 2% of the received application traffic to under-test application component 122_{U} until testing of the under-test application component 122_{U} is complete and a determination is made as to whether or not the under-test application component 122_{U} may be put into full service for handling of application traffic (i.e., moved to the set of in-service application components 122_{I}, which would result in eleven total in-service application components 122_{I} for cloud-based application such that each in-service application component 122_{I} would then only need to handle approximately 9% of the application traffic for cloud-based application). This enables online testing of under-test application component 122_{U} using real application traffic without risking a significant portion of the application traffic.

In at least some embodiments, the size of the second portion of application traffic that is directed to the under-test application component 122_{U} may be dynamically increased over time until proper operation of the under-test application component 122_{U} is validated and the under-test application component 122_{U} can be put into full service for handling of application traffic (i.e., changed from the UNDER-TEST state to the IN-SERVICE state, such that it is moved to the set of in-service application components 122_{I}). In at least some embodiments, the trigger for increasing the second portion of application traffic that is directed to the under-test application component 122_{U} may be temporal. For example, the size of the second portion of application traffic that is directed to the under-test application component 122_{U} may be increased once each time period (e.g., hour, day, or the like) as long as under-test application component 122_{U} does not experience any problems with handling of the second portion of application traffic that is directed to the under-test application component 122. In at least some embodiments, the trigger for increasing the second portion of application traffic that is directed to the under-test application component 122_{U} may be validation of proper operation of the under-test application component 122_{U} for the current size of the second portion of application traffic that is directed to the under-test application component 122_{U}. For example, the size of the second portion of application traffic that is directed to the under-test application component 122_{U} may be a first size for the first 100 transactions, a second size (which is greater than the first size) for the next 500 transactions if the under-test application component 122_{U} operates properly at the first size, and so forth. It will be appreciated that other triggers may be used for increasing the second portion of application traffic that is directed to the under-test application component 122_{U}. The increase in the second portion of application traffic that is directed to the under-test application component 122_{U} may be incremental (e.g., based on percentage of received application traffic, amount of received application traffic, or the like), dynamically determined based on one or more factors (e.g., handling by under-test application component 122_{U} of the current size of the second portion of application traffic that is directed to the under-test application component 122_{U}, complexity of the functions of the cloud-based application 120, or the like), or the like, as well as various combinations thereof. For example, in continuation of the example discussed above in which there are ten in-service application components 122_{I}, the application load balancer 130 may initially direct 2% of the received application traffic to under-test application component 122_{U}, increase the size of the second portion of application traffic that is directed to the under-test application component 122_{U} in 1% increments until reaching 6%, and then determine whether the under-test application component 122_{U} is functioning properly such that the under-test application component 122_{U} may be put into full service for handling of application traffic (which will be approximately 9% each where the application traffic is distributed across the eleven in-service application components evenly). For example, in continuation of the example discussed above in which there are ten in-service application components 122_{I}, the application load balancer 130 may initially direct 1% of the received application traffic to under-test application component 122_{U}, increase the size of the second portion of application traffic that is directed to the under-test application component 122_{U} to 3% and then to 7%, and then determine whether the under-test application component 122_{U} is functioning properly such that the under-test application component 122_{U} may be put into full service for handling of application traffic (which, again, will be approximately 9% each where the application traffic is distributed across the eleven in-service application components evenly). For example, the application load balancer 130 may initially direct ten one-at-a-time transactions to the under-test application component 122, then direct twenty two-at-a-time transactions to the under-test application component 122_{U} based on verification that under-test application component 122_{U} successfully handled the ten one-at-a-time transactions, and so forth, until a determination is made that the under-test application component 122_{U} is functioning properly such that the under-test application component 122_{U} may be put into full service for handling of application traffic. This enables online testing of under-test application component 122_{U} using real application traffic in a controlled manner that enables the under-test application component 122_{U} to slowly assume responsibility for handling of additional application traffic when the under-test application component 122_{U} is deemed to be ready to handle additional application traffic.

Thus, from the foregoing embodiments and examples in which application traffic (rather than dedicated test traffic) is used to test the under-test application component 122_{U}, it will be appreciated that use of the term “full service” denotes that, where a portion of application traffic is used to test the under-test application component 122_{U}, the under-test application component 122 may be considered to be partially in-service (even though its state is UNDER-TEST) since it is handling at least some application traffic for cloud-based application 120 while being tested and validated.

The under-test application component 122_{U} may be appropriately managed based on the results of testing of under-test application component 122. If the proper operation of under-test application component 122_{U} is verified based on the results of testing of under-test application component 122_{U}, the under-test application component 122_{U} may be put into full service as part of the set of in-service application components 122_{I} (e.g., changing the state of the under-test application component 122_{U} from UNDER-TEST to IN-SERVICE such that the application load balancer 130 recognizes it as being an in-service application component 122_{I}). If the proper operation of under-test application component 122_{U} is not verified based on the results of testing of under-test application component 122_{U}, the under-test application component 122_{U} is not put into full service as part of the set of in-service application components 122_{I}; rather, the under-test application component 122_{U} may be managed in any other suitable manner (e.g., deleting the under-test application component 122_{U}, marking the under-test application component 122_{U} as requiring reconfiguration, marking the under-test application component 122_{U} as requiring additional testing, or the like).

It will be appreciated that, although omitted for purposes of clarity and generality, management of the application components 122 of the cloud-based application 120 may be performed by any suitable management entity or entities (e.g., by application load balancer 130, by a separate entity or entities cooperating with application load balancer 130 to support testing and verification of under-test application components, or the like). For example, where application load balancer 130 is configured to perform application management functions, application load balancer 130 may be configured to control the grown of cloud-based application 120 using under-test application component 122_{U}, direct traffic to under-test application component 122_{U} for testing of under-test application component 122_{U}, analyze the results of testing of under-test application component 122_{U}, and take appropriate action based on analysis of the results of testing of under-test application component 122_{U} (e.g., where testing is successful the application load balancer 130 may move the under-test application component 122_{U} to the set of in-service application components 122_{I} for handling of live application traffic, where testing is unsuccessful the application load balancer 130 may delete the under-test application component 122_{U}, or the like). For example, an application management entity control the grown of cloud-based application 120 using under-test application component 122_{U} and inform application load balancer 130 that under-test application component 122_{U} needs to be tested, the application load balancer 130 may direct traffic to under-test application component 122_{U} for testing of under-test application component 122_{U}, and the application management entity may analyze the results of testing of under-test application component 122_{U} and take appropriate action based on analysis of the results of testing of under-test application component 122_{U} (e.g., where testing is successful the application management entity may inform the application load balancer 130 that the under-test application component 122_{U} has been moved to the set of in-service application components 122_{I} and can now handle live application traffic, where testing is unsuccessful the application management entity may delete the under-test application component 122_{U} and inform the application load balancer 130 that the under-test application component 122_{U} has been deleted, or the like). Various other implementations are contemplated.

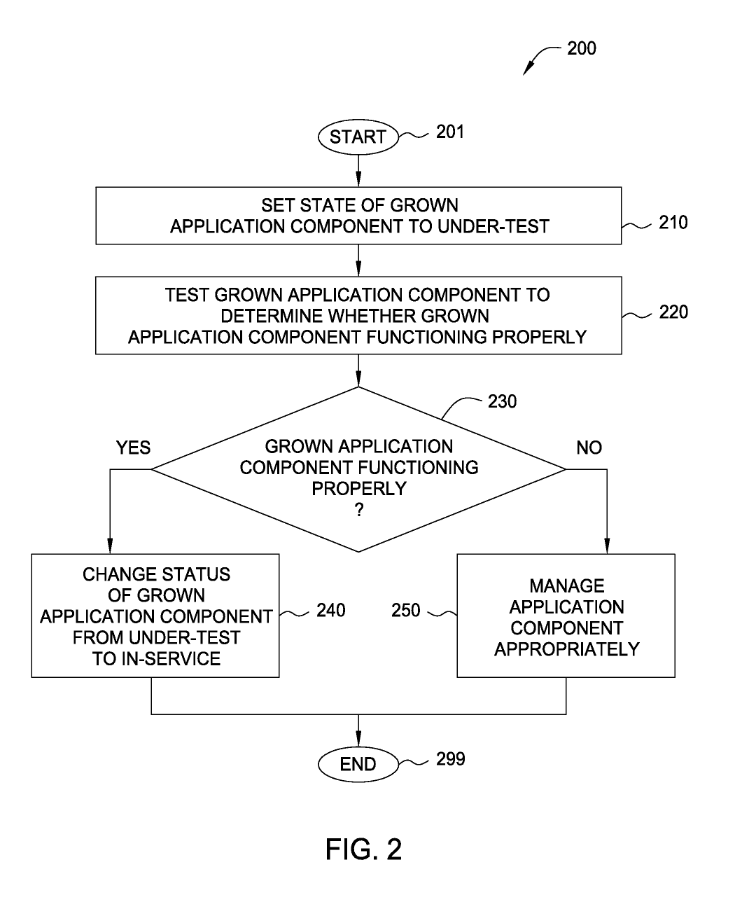

FIG. 2 depicts an exemplary embodiment of a method for online application testing of grown application capacity for a cloud-based application having a set of in-service application components. It will be appreciated that, although primarily depicted and described as being performed serially, at least a portion of the steps of method 200 may be performed contemporaneously or in a different order than depicted in FIG. 2. It is noted that, given the various implementation scenarios discussed above, the steps of method 200 may be performed by a single element or distributed across multiple elements. At step 201, method 200 begins. At step 210, a grown application component providing growth of the application capacity of the cloud-based application is set to an UNDER-TEST state. At step 220, the grown application component is tested to determine whether the grown application component is functioning properly. At step 230, a determination is made, based on the results of the testing of the grown application component, as to whether the grown application component is functioning properly. If the grown application component is determined to be functioning properly, method 200 proceeds to step 240, at which point the grown application component is moved from the UNDER-TEST state to an IN-SERVICE state (i.e., the grown application component becomes part of the set of in-service application components of the cloud-based application). If the grown application component is determined not to be functioning properly, method 200 proceeds to step 250, at which point the grown application component may be managed appropriately (e.g., deletion of the grown application component, reconfiguration of the grown application component, or the like). From steps 240 and 250, method 200 proceeds to step 299, where method 200 ends. The various steps of method 200 may be better understood by way of reference to FIG. 1.

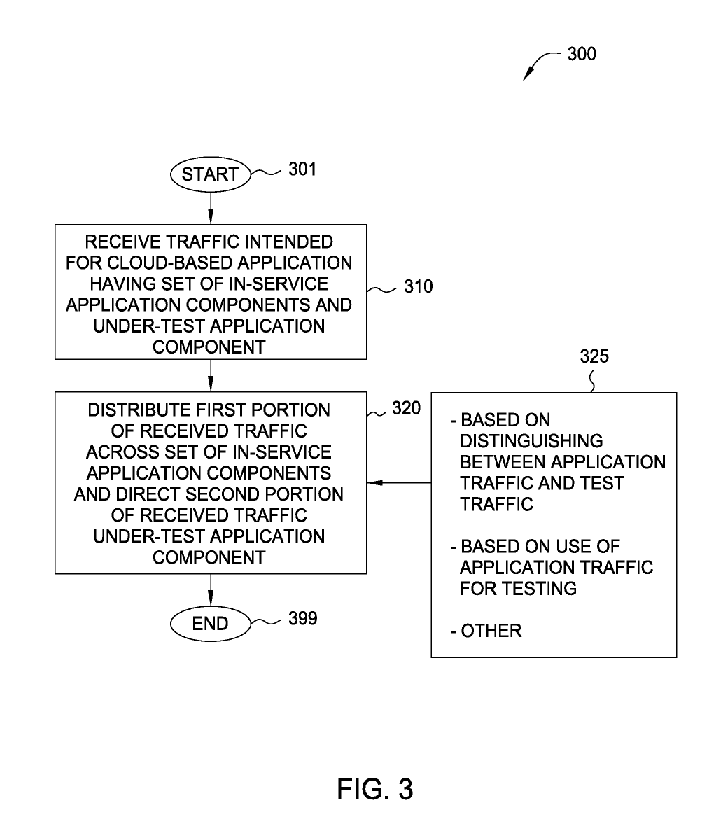

FIG. 3 depicts an exemplary embodiment of a method for online application testing of grown application capacity for a cloud-based application having a set of in-service application components. It will be appreciated that, although primarily depicted and described as being performed serially, at least a portion of the steps of method 300 may be performed contemporaneously or in a different order than depicted in FIG. 3. At step 301, method 300 begins. At step 310, traffic intended for the cloud-based application is received. At step 320, a first portion of the received traffic is distributed across the set of in-service application components and a second portion of the received traffic is directed to the under-test application component. As indicated by box 325, handling of the received traffic depends on whether the received traffic includes test traffic. For example, handling of the received traffic may include distinguishing between application traffic and test traffic (e.g., such that step 320 may include or be preceded by a decision step in which a determination is made as to whether a given packet of the received traffic is an application packet or a test packet), and distributing the application traffic across the in-service application components and directing the test traffic to the under-test application component. For example, handling of the received traffic may include distributing a first portion of application traffic across the in-service application components and directing a second portion of application traffic to the under-test application component. At step 399, method 300 ends. The various steps of method 300 may be better understood by way of reference to FIG. 1.

It will be appreciated that, although depicted and described with respect to embodiments for testing and validation of a single under-test application component, multiple under-test application components may be tested and validated as described herein. For example, in at least some embodiments in which test traffic is used for testing and validation of grown application capacity, the application load balancer may be configured to distribute the test traffic across the multiple under-test application components in various ways. For example, in at least some embodiments in which application traffic is used for testing and validation of grown application capacity, the application load balancer may be configured to distribute the portion of application traffic selected for use in testing and validating the multiple under-test application components across the across the multiple under-test application components in various ways.

It will be appreciated that, although depicted and described with respect to embodiments in which either test traffic or application traffic is used to test an under-test application component, in at least some embodiments a combination of test traffic and application traffic may be used to test an under-test application component or a set of under-test application components. It will be appreciated that such embodiments may include any combinations of embodiments for use of test traffic as depicted and described herein and embodiments for use of application traffic as depicted and described herein.

It will be appreciated that although the term “application components” is used herein to refer to elements of the cloud-based application (e.g., VMs providing functions of the cloud-based application), the term “application component instances” may be used in place of “application components” to refer to elements of the cloud-based application (again, e.g., VMs providing functions of the cloud-based application).

Various embodiments of the capability for online application testing of grown application capacity provide advantages for cloud-based applications. For example, various embodiments of the capability for online application testing of grown application capacity obviate the need to take the cloud-based application offline in order to grow the application capacity of the cloud-based application, which would increase operational complexity (and, thus, costs) and would likely impact service provided by the cloud-based application. For example, various embodiments of the capability for online application testing of grown application capacity obviate the need for reliance on an indication from an application management entity that grown application components are ready for service when the application management entity does not have an adequate basis for providing the indication that the grown application components are ready for service. For example, various embodiments of the capability for online application testing of grown application capacity reduce or minimize the risk that application users will experience poor quality of service due to sending of associated application traffic to newly grown and inoperable or faulty application capacity. Various other advantages are contemplated.

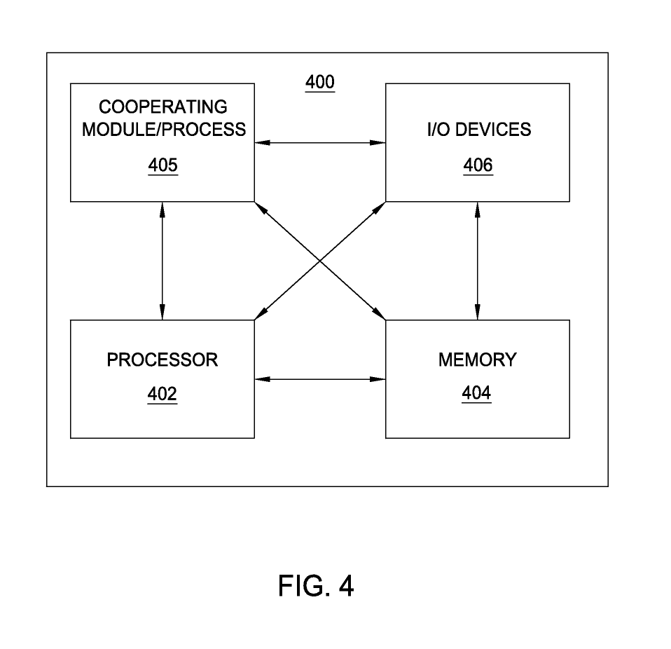

FIG. 4 depicts a high-level block diagram of a computer suitable for use in performing functions described herein.

The computer 400 includes a processor 402 (e.g., a central processing unit (CPU) and/or other suitable processor(s)) and a memory 404 (e.g., random access memory (RAM), read only memory (ROM), and the like).

The computer 400 also may include a cooperating module/process 405. The cooperating process 405 can be loaded into memory 404 and executed by the processor 402 to implement functions as discussed herein and, thus, cooperating process 405 (including associated data structures) can be stored on a computer readable storage medium, e.g., RAM memory, magnetic or optical drive or diskette, and the like.

The computer 400 also may include one or more input/output devices 406 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 400 depicted in FIG. 4 provides a general architecture and functionality suitable for implementing functional elements described herein and/or portions of functional elements described herein. For example, the computer 400 provides a general architecture and functionality suitable for implementing one of the application traffic sources 102, one of the application components 122, application load balancer 130, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive traffic intended for a cloud-based application, the cloud-based application comprising a set of in-service application components and an under-test application component;
distribute a first portion of the received traffic across the set of in-service application components; and
direct a second portion of the received traffic to the under-test application component.

2. The apparatus of claim 1, wherein the received traffic comprises application traffic and test traffic, wherein the processor is configured to:
distinguish the application traffic from the test traffic;
distribute the application traffic across the set of in-service application components; and
direct the test traffic to the under-test application component.

3. The apparatus of claim 2, wherein the processor is configured to distinguish the application traffic from the test traffic based on at least one of source address information included in packets of the received traffic or test traffic indicator information included in packets of the received traffic.

4. The apparatus of claim 1, wherein the received traffic comprises application traffic, wherein the processor is configured to:
distribute a first portion of the application traffic across the set of in-service application components; and
direct a second portion of the application traffic to the under-test application component.

5. The apparatus of claim 4, wherein the second portion of the application traffic is determined as a percentage of the received application traffic, as an amount of the received application traffic, or based on temporal considerations.

6. The apparatus of claim 4, wherein the second portion of the application traffic directed to the under-test application component includes less application traffic than is directed to any of the in-service application components.

7. The apparatus of claim 4, wherein the processor is configured to dynamically increase a size of the second portion of the application traffic directed to the under-test application component.

8. A method, comprising:
using a processor and a memory for:
receiving traffic intended for a cloud-based application, the cloud-based application comprising a set of in-service application components and an under-test application component;
distributing a first portion of the received traffic across the set of in-service application components; and
directing a second portion of the received traffic to the under-test application component.

9. The method of claim 8, wherein the received traffic comprises application traffic and test traffic, the method comprising:
distinguishing the application traffic from the test traffic;
distributing the application traffic across the set of in-service application components; and
directing the test traffic to the under-test application component.

10. The method of claim 9, wherein distinguishing the application traffic from the test traffic is based on at least one of source address information included in packets of the received traffic or test traffic indicator information included in packets of the received traffic.

11. The method of claim 8, wherein the received traffic comprises application traffic, the method comprising:
distributing a first portion of the application traffic across the set of in-service application components; and
directing a second portion of the application traffic to the under-test application component.

12. The method of claim 11, wherein the second portion of the application traffic is determined as a percentage of the received application traffic, as an amount of the received application traffic, or based on temporal considerations.

13. The method of claim 11, wherein the second portion of the application traffic directed to the under-test application component includes less application traffic than is directed to any of the in-service application components.

14. The method of claim 11, further comprising:
dynamically increasing a size of the second portion of the application traffic directed to the under-test application component.

15. A computer-readable storage medium storing instructions which, when executed by a computer, cause the computer to perform a method, the method comprising:
receiving traffic intended for a cloud-based application, the cloud-based application comprising a set of in-service application components and an under-test application component;
distributing a first portion of the received traffic across the set of in-service application components; and
directing a second portion of the received traffic to the under-test application component.

16. The computer-readable storage medium of claim 15, wherein the received traffic comprises application traffic and test traffic, the method comprising:
distinguishing the application traffic from the test traffic;
distributing the application traffic across the set of in-service application components; and
directing the test traffic to the under-test application component.

17. The computer-readable storage medium of claim 16, wherein distinguishing the application traffic from the test traffic is based on at least one of source address information included in packets of the received traffic or test traffic indicator information included in packets of the received traffic.

18. The computer-readable storage medium of claim 15, wherein the received traffic comprises application traffic, the method comprising:
distributing a first portion of the application traffic across the set of in-service application components; and
directing a second portion of the application traffic to the under-test application component.

19. The computer-readable storage medium of claim 18, wherein the second portion of the application traffic is determined as a percentage of the received application traffic, as an amount of the received application traffic, or based on temporal considerations.

20. The computer-readable storage medium of claim 18, wherein the second portion of the application traffic directed to the under-test application component includes less application traffic than is directed to any of the in-service application components.

21. The computer-readable storage medium of claim 18, the method further comprising:
dynamically increasing a size of the second portion of the application traffic directed to the under-test application component.
